(19) United States
(12) Patent Application Publication
(10) Pub. No.: US 2005/0207293 A1
(43) Pub. Date: Sep. 22, 2005

(54) Recording medium and method for recording and reproducing data on and from the same

(76) Inventor: Jin Yong Kim, Kyunggi-do (KR)

Correspondence Address: HARNESS, DICKEY & PIERCE, P.L.C., P.O. BOX 8910, RESTON, VA, 20195, US

(21) Appl. No.: 11/079,873

(22) Filed: Mar. 15, 2005

(30) Foreign Application Priority Data
Mar. 16, 2004 (KR) 10-2004-0017780
Mar. 4, 2005 (KR) 10-2005-0018221

(51) Int. Cl. G11B 7/24

(52) U.S. Cl. 369/47.22

(57) ABSTRACT

A recording medium and a method for recording and reproducing data on and from the recording medium are provided. Identification information, indicating which one of an in-groove recording method and an on-groove recording method has been or will be used to record data, is recorded in a specific area, such as a Burst Cutting Area (BCA) and a Permanent Information & Control data (PIC) area, of a recording medium such as a Blue-ray Disc (BD) on which a land and a groove are formed. The on-groove recording method or the in-groove recording method selected based on the identification information recorded in the specific area is used to record or reproduce data on or from the recording medium. This allows the in-groove recording method to be backward-compatibly applied to recording media.

### BACKGROUND OF THE INVENTION

1. Field of the Invention

The present invention relates to a recording medium such as a Blue-ray Disc (BD) on which a land and a groove are formed, and a method for recording and reproducing data on and from the recording medium.

2. Description of the Related Art

As the standardization of a new high-density optical disc, for example, a Blue-ray Disc-Rewritable (BD-RE), which can store lengthy high-quality audio and video data, has rapidly advanced, it is expected that a number of associated products will be developed and commercialized in the near future.

As shown in FIG. 1, the BD-RE has a disc structure in which a clamping area, a transition area, a Burst Cutting Area (BCA), and a lead-in area are sequentially arranged in an inner section of the disc, a data area is arranged in a middle section of the disc, and a lead-out area is arranged in an outer section of the disc.

The lead-in area is divided into a first guard (Guard 1) area, a Permanent Information & Control data (PIC) area, a second guard (Guard 2) area, and an Optimum Power Control (OPC) area. The first guard area and the PIC area in the lead-in area are pre-recorded areas in which data is previously recorded. The other areas of the lead-in area, the data area, and the lead-out area are rewritable areas in which data may be rewritten.

The PIC area is an area in which primary disc information to be permanently preserved is stored. A High Frequency Modulated (HFM) groove is formed in the PIC area. The HFM groove is bi-phase modulated to store disc information as shown in FIG. 2.

Along with the development of the BD-RE, the standardization of a read-only BD (i.e., BD-ROM) and a write-once or recordable BD (i.e., BD-R) is under discussion between the members of the BD consortium. For example, the BD-R has an inner area, a clamping area, a transition area, an information area, and a rim area, as shown in FIG. 3. The information area is divided into a BCA in which information is recorded in barcode format, and a PIC area in which disc information is recorded.

The BD-RE employs on-groove recording in which data is recorded on a groove as shown in FIG. 4.

The on-groove recording is a recording method in which the groove is nearer to a beam entrance surface of the disc than the land. This indicates that the groove is depressed when viewed from the top surface of the disc.

On the other hand, the BD-R may be manufactured through a low-cost manufacturing method in which dye material is coated on the disc through spin coating in the same manner as general CD-R. To improve a jitter property of the manufactured BD-R, in-groove recording, in which data is recorded in the groove as shown in FIG. 5, is more suitable than the on-groove recording in which data is recorded on the groove as shown in FIG. 4.

The in-groove recording is a recording method in which the groove is farther from the beam entrance surface of the disc than the land. This indicates that the groove is elevated when viewed from the top surface of the disc.

However, if data is recorded in the BD-R in the in-groove recording method, an optical disc device such as a disc recorder or a disc player needs to select a reproducing method, suitable for an optical disc inserted in the device, from among reproducing methods corresponding respectively to the in-groove and on-groove recording methods. However, no effective solution to this need has been provided, and there is an urgent need to provide such an effective solution.

### SUMMARY OF THE INVENTION

Therefore, the present invention has been made in view of the above problems, and it is an object of the present invention to provide a method for managing information indicating which one of an on-groove recording method and an in-groove recording method has been or will be used to record data on a recording medium on which a land and a groove are formed.

It is another object of the present invention to provide a method for selecting recording and reproducing methods suitable for a recording medium, on which data has been or will be recorded in the on-groove recording method or the in-groove recording method, so as to properly record and reproduce data on and from the recording medium.

It is yet another object of the present invention to provide a recording medium which can record data in the on-groove recording method or the in-groove recording method and manage information indicating a data recording method.

In accordance with one aspect of the present invention, the above and other objects can be accomplished by the provision of a method for recording data on a recording medium, the method comprising: recording identification information, indicating which one of an on-groove recording method and an in-groove recording method is used to record data, in a specific area of the recording medium.

In accordance with another aspect of the present invention, there is provided a recording medium comprising a specific area in which identification information, indicating which one of an on-groove recording method and an in-groove recording method is to be used to record data, is recorded.

In accordance with still another aspect of the present invention, there is provided a method for recording/reproducing data on/from a recording medium, the method comprising: (a) determining which one of an on-groove recording method and an in-groove recording method has been or will be used to record data on the recording medium; and (b) recording or reproducing data on or from the recording medium as a result of the step (a).

Preferably, the recording medium is a rewritable Blue-ray Disc (BD-RE) or a recordable Blue-ray Disc (BD-R), and the specific area is assigned to a Burst Cutting Area (BCA) or a lead-in area of the recording medium. The specific area can be assigned to a Permanent Information & Control data (PIC) area of the lead-in area.

Preferably, the identification information indicates either the on-groove recording method or a reserved state other than the on-groove recording method.

In accordance with yet another aspect of the present invention, there is provided a method for recording/reproducing data on/from a recording medium, the method comprising: (a) decoding data recorded in a specific area of the recording medium in a reproducing method corresponding to an on-groove recording method; and (b) recording data in an in-groove recording method or reproducing data in a reproducing method corresponding to the in-groove recording method if the decoding is not performed normally in the reproducing method corresponding to the on-groove recording method.

Preferably, the specific area is a bi-phase modulated PIC area.

Preferably, the step (b) comprises a step of changing a servo operation for recording or reproducing data on or from the recording medium if the decoding is not performed normally in the reproducing method corresponding to the on-groove recording method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a disc structure of a rewritable Blue-ray Disc (BD-RE);

FIG. 2 illustrates a High Frequency Modulated (HFM) groove formed in a Permanent Information & Control data (PIC) area of the BD-RE;

FIG. 3 illustrates a disc structure of a recordable Blue-ray Disc (BD-R);

FIG. 4 illustrates an exemplary on-groove recording method;

FIG. 5 illustrates an exemplary in-groove recording method;

FIG. 6 illustrates a structure of a recording medium according to the present invention; and

FIG. 7 illustrates the configuration of an optical disc device to which a method for recording and reproducing data on and from a recording medium according to the present invention is applied.

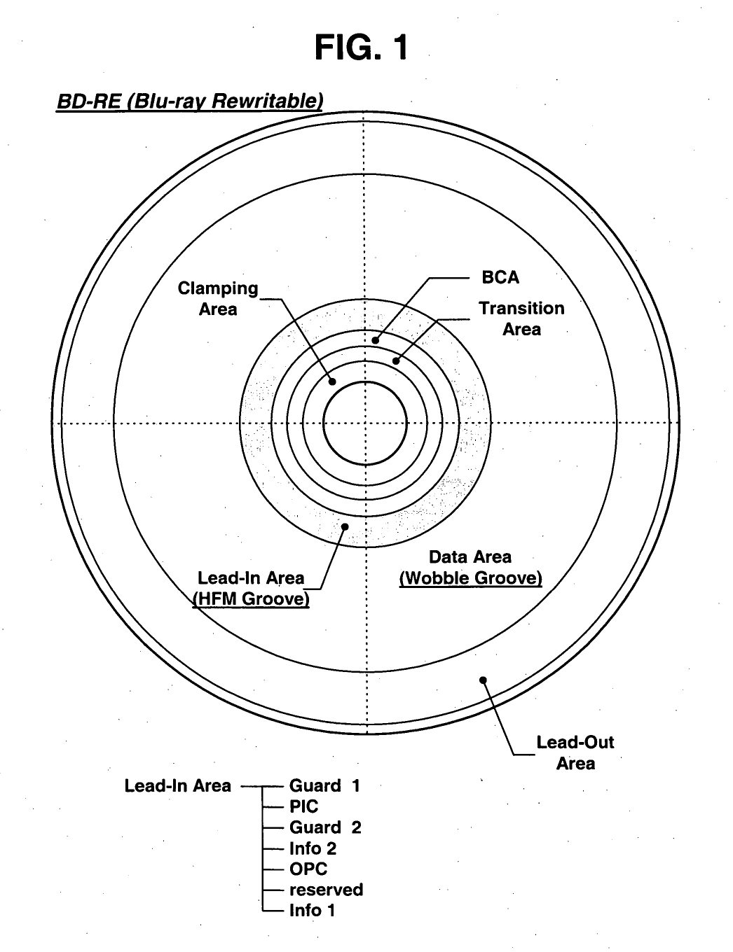

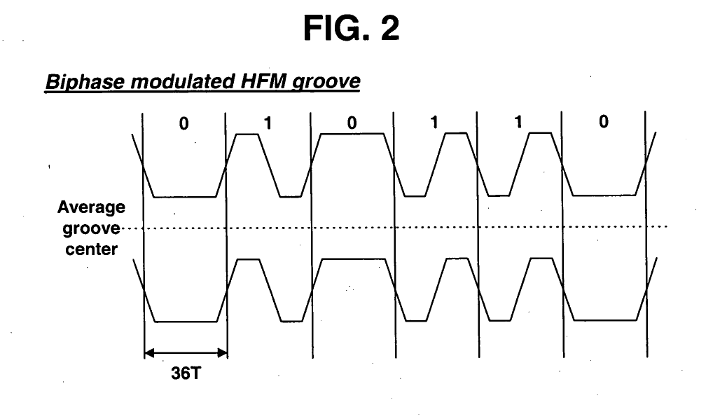

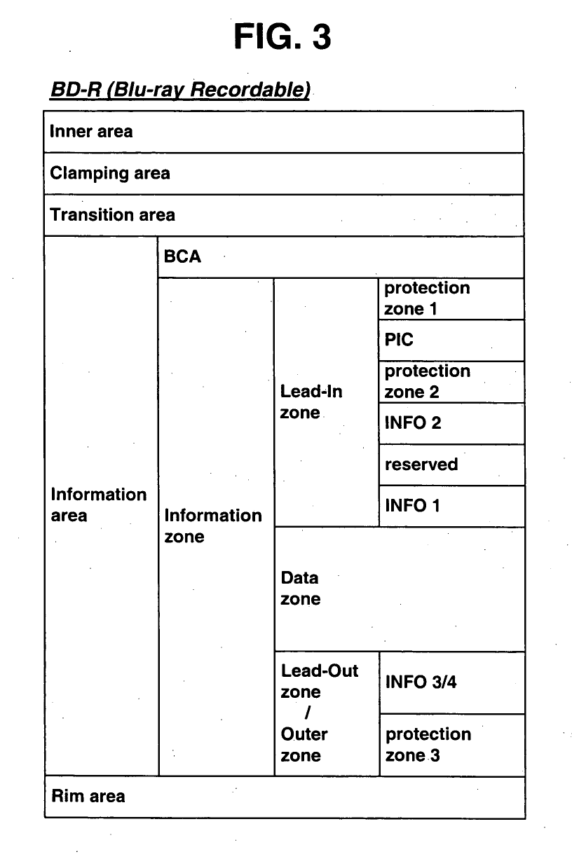

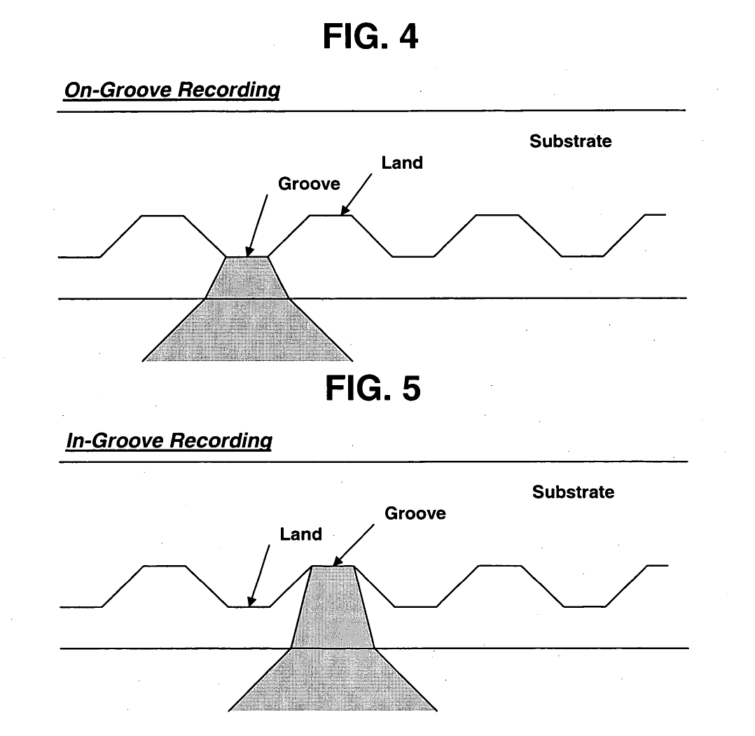

### DETAILED DESCRIPTION OF PREFFERRED EMBODIMENTS

Preferred embodiments of a recording medium and a method for recording and reproducing data on and from the recording medium according to the present invention will now be described in detail with reference to the accompanying drawings.

The present invention can be applied not only to BD-R but also to other various types of blue-ray discs such as BD-RE and BD-ROM. The data recording method according to the present invention can be applied to an apparatus for authoring a BD-R or the like, and the data recording and reproducing method according to the present invention can be applied to an optical disc device such as a disc recorder or a disc player.

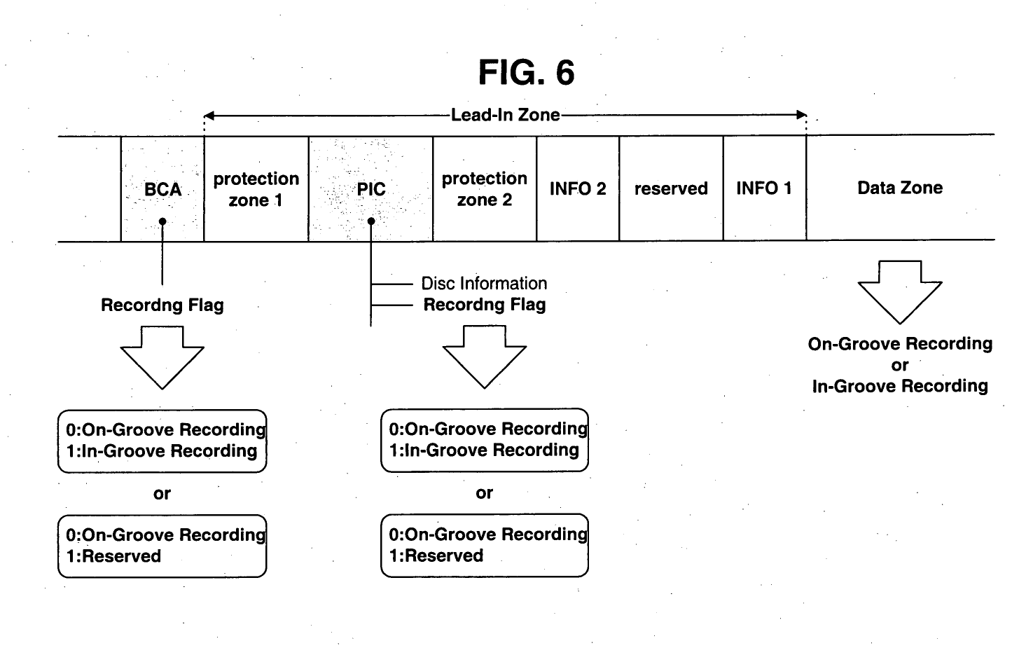

The disc authoring apparatus, to which the data recording method according to the present invention is applied, records identification information, which indicates a method for recording data in a data zone of a BD-R shown in FIG. 6, in a specific area of the BD-R.

As shown in FIG. 6, a flag bit (for example, Recording Flag) indicating the on-groove recording method or the in-groove recording method can be recorded in barcode format in a BCA of the BD-R. The flag bit, together with Disc Information (DI), can be recorded in a PIC area of the BD-R. The flag bit can be recorded in one or both of the BCA and the PIC area.

If the flag bit is ‘1’, it indicates the on-groove recording method, and if the flag bit is ‘0’, it indicates the in-groove recording method or indicates a reserved state instead of the on-groove recording method.

If the flag bit indicates the reserved state, the recording system starts recording and reproducing of data on and from the disc, using the on-groove recording method by default. However, if an HFM signal of the PIC area of the disc is not decoded, it is determined that the corresponding recording method is the in-groove recording method rather than the on-groove recording method, and the tracking polarity is changed. This provides extensibility of the recording method to media (i.e., the disc) so that the media can record data in the in-groove recording method in the future, and also allows the recording system to maintain compatibility with the conventional recording systems that support only the on-groove recording method. These are benefits provided by assigning the reserved state to the flag bit.

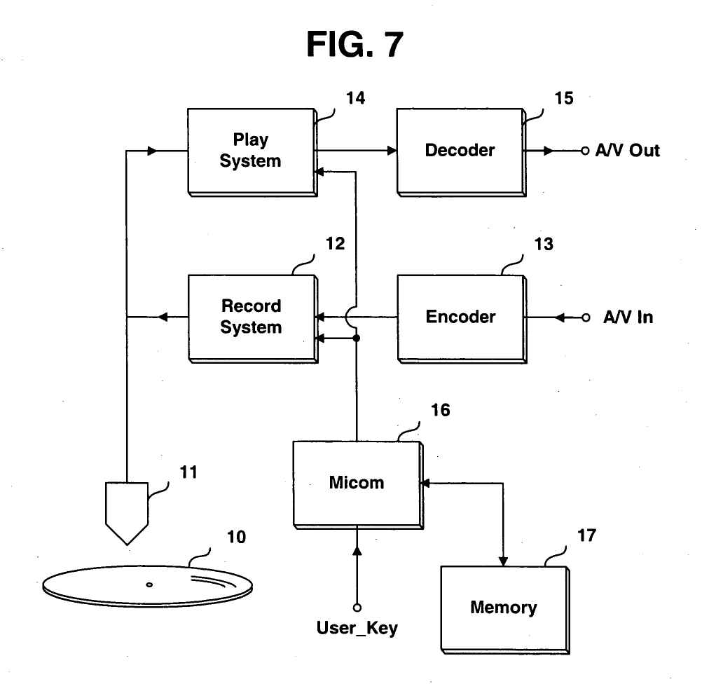

The data recording and reproducing method according to another embodiment of the present invention can be applied to an optical disc device such as a disc recorder or a read-only disc player. As shown in FIG. 7, the disc recorder may include an optical pickup 11, a record system 12, an encoder 13, a play system 14, a decoder 15, a microcomputer 16, and a memory 17.

If a BD-R 10 is inserted into the device, the microcomputer 16 controls the operation of the play system 14 to confirm a flag bit recorded in a BCA or a PIC area of the inserted BD-R 10.

If the confirmed flag bit is “1”, the microcomputer 16 determines that data has been or will be recorded on the BD-R in the on-groove recording method, and thus records data in the on-groove recording method or reproduces data in a playback method corresponding to the on-groove recording method. If the confirmed flag bit is “0”, the microcomputer 16 determines that data has been or will be recorded on the BD-R in a recording method different from the on-groove recording method (i.e., in the in-groove recording method), and thus records data in the in-groove recording method or reproduces data in a playback method corresponding to the in-groove recording method.

In another embodiment of the present invention, the microcomputer 16 first decodes data of the PIC area, which is HF (High Frequency) modulated through bi-phase modulation, through a reproducing method corresponding to the on-groove recording method. If the decoding is performed normally, the microcomputer 16 determines that data has been or will be recorded on the BD-R in the on-groove recording method, and thus maintains the on-groove recording method and the reproducing method corresponding to the on-groove recording method.

On the other hand, if the decoding is not performed normally, the microcomputer 16 determines that data has been or will be recorded on the BD-R in a recording method other than the on-groove recording method (i.e., in the in-groove recording method), and thus performs data recording and reproducing after changing the recording and reproducing methods to the in-groove recording method and a reproducing method corresponding to the in-groove recording method.

As is apparent from the above description, a recording medium and a method for recording and reproducing data on and from the recording medium according to the present invention have an advantage in that the in-groove recording method having an improved jitter property can be backward-compatibly applied to recording media.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for recording data on a recording medium, the method comprising:
recording identification information, indicating which one of an on-groove recording method and an in-groove recording method is used to record data, in a specific area of the recording medium.

2. The method according to claim 1, wherein the recording medium is a high-density optical disc, which is a rewritable Blue-ray Disc (BD-RE) or a recordable Blue-ray Disc (BD-R).

3. The method according to claim 2, wherein the specific area is assigned to a Burst Cutting Area (BCA) and/or a lead-in area of the high-density optical disc.

4. The method according to claim 3, wherein the specific area is assigned to Permanent Information & Control data (PIC) area of the lead-in area.

5. The method according to claim 1, wherein the identification information indicates either the on-groove recording method or a reserved state other than the on-groove recording method.

6. A recording medium comprising:
a specific area in which identification information, indicating which one of an on-groove recording method and an in-groove recording method is to be used to record data, is recorded.

7. The recording medium according to claim 6, wherein the recording medium is a high-density optical disc, which is a rewritable Blue-ray Disc (BD-RE) or a recordable Blue-ray Disc (BD-R).

8. The recording medium according to claim 7, wherein the specific area is a Burst Cutting Area (BCA) and/or a lead-in area.

9. The recording medium according to claim 8, wherein the identification information is recorded in a Permanent Information & Control data (PIC) area of the lead-in area.

10. The high-density optical disc according to claim 6, wherein the identification information indicates either the on-groove recording method or a reserved state other than the on-groove recording method.

11. A method for recording/reproducing data on/from a recording medium, the method comprising:
(a) determining which one of an on-groove recording method and an in-groove recording method has been or will be used to record data on the recording medium; and
(b) recording or reproducing data on or from the recording medium as a result of the step (a).

12. The method according to claim 11, wherein the step (a) is based on identification information recorded in a Burst Cutting Area (BCA) or a lead-in area of the recording medium.

13. The method according to claim 12, wherein the identification information is recorded in a Permanent Information & Control data (PIC) area of the lead-in area.

14. The method according to claim 11, wherein the step (b) comprises a step of controlling a servo operation for recording or reproducing data on or from the recording medium as a result of the step (a).

15. A method for recording/reproducing data on/from a recording medium, the method comprising:
(a) decoding data recorded in a specific area of the recording medium in a reproducing method corresponding to an on-groove recording method; and
(b) recording data in an in-groove recording method or reproducing data in a reproducing method corresponding to the in-groove recording method if the decoding is not performed normally in the reproducing method corresponding to the on-groove recording method.

16. The method according to claim 15, wherein the specific area is a lead-in area.

17. The method according to claim 16, wherein the specific area is a bi-phase modulated PIC area of the lead-in area.

18. The method according to claim 15, wherein the step (b) comprises a step of changing a servo operation for recording or reproducing data on or from the recording medium if the decoding is not performed normally in the reproducing method corresponding to the on-groove recording method.
